(19) United States
(12) Patent Application Publication
(10) Pub. No.: US 2017/0247229 A1
(43) Pub. Date: Aug. 31, 2017

(54) Breaching Sling System

(71) Applicant: Black Mountain Industries, Inc., Bryan, TX (US)

(72) Inventors: Kyle L. Greenwood, Bryan, TX (US); Chris Daniel, Bryan, TX (US); James Buckner, Bryan, TX (US)

(73) Assignee: Black Mountain Industries, Inc., Bryan, TX (US)

(21) Appl. No.: 15/056,590

(22) Filed: Feb. 29, 2016

(51) Int. Cl. B66C 1/14; B66C 1/36

(52) U.S. Cl. CPC B66C 1/14; B66C 1/36

(57) ABSTRACT

A breach sling system used to quickly and efficiently remove material and items. Using this system may allow law enforcement personnel to quickly remove material and items such as doors and windows from structures, which allows law enforcement to quickly breach and enter a structure. Breaching hooks, used by law enforcement personnel, may be embedded into material and items. Attached to ropes, the breaching hooks may be pulled using a vehicle, which may exert enough force on the material and items to remove them from a structure.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

Field of the Invention

The field of invention is directed to a breaching tool sling system, and more specifically a breaching tool sling system that uses a breaching hook and rope to remove structures.

Background of the Invention

Currently, the law enforcement industry needs a technology that can enhance the ability of law enforcement officials to breach structures quickly, quietly, and efficiently. The inability to enter structures quickly may lead to placing law enforcement personnel and civilians in dangerous conditions. Entering a building quickly may prevent the destruction of evidence and lessen the amount of time law enforcement is in a dangerous situation. Past and current systems have not been sufficient, individually, in increasing the safety and lessening the time for law enforcement to breach a structure. Often, several officers are needed with battering rams and heavy equipment to breach a structure. This may be rather expensive, require more law enforcement personnel, and heavy equipment to breach a structure.

Consequently, there is a need for a single inexpensive system that law enforcement personnel can use quickly and efficiently to breach structures. With the increasing implementation of security cameras, burglar bars, hardened entry points, and alarm systems, law enforcement needs a quick and efficient device to enter a structure before a suspect is notified of the law enforcement's presence. The breach sling system of this disclosure may enhance the ability for law enforcement to enter a structure quickly, without notifying suspects of the law enforcement's presence.

### BRIEF SUMMARY OF SOME OF THE PREFERRED EMBODIMENTS

These and other needs in the art are addressed in an embodiment by a breach sling system and method, which may comprise a plurality of ropes, where at least two of the ropes may be attached to each other, and wherein at least one rope may comprise a small loop at one end and a large loop at an opposing end. The breach sling system may also comprise a breaching hook.

In embodiment, a method for deploying a breach sling system may comprise opening a carry bag, removing a deployment bag from the carry bag, pulling a rip cord to release a breaching hook and at least one rope, attaching a lead rope to the at least one rope, attaching the lead rope to a vehicle, attaching the breaching hook to a structure, driving the vehicle away from the structure.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a plurality of ropes connected together;

Figure la illustrates another embodiment of connected ropes;

FIG. 2 illustrates an embodiment of a breaching hook with a gate;

FIG. 3 illustrates a gate used on a breaching hook;

FIG. 4 illustrates a breaching hook without a gate attached;

FIG. 5 illustrates an embodiment of a breaching hook;

FIG. 6 illustrates an alternate embodiment of a breaching hook;

FIG. 7 illustrates an alternate embodiment of a breaching hook;

FIG. 8 illustrates the inner compartment of a deployment bag;

FIG. 8a illustrates the inner compartment of a deployment bag securing a plurality of ropes;

FIG. 9 illustrates a row of restraint loops;

FIG. 10 illustrates the outer wall of a deployment bag;

FIG. 11 illustrates a carry bag;

FIG. 12 illustrate a breach sling system deployed with an additional lead rope and breaching hook; and

FIG. 13 illustrates a vehicle connected with a lead rope and rope.

### DETAILED DESCRIPTION OF THE PREFERRED EMBODIMENTS

Embodiments of a breach sling system 5 may allow for law enforcement to quickly breach a structure. Embodiments may further comprise a method of operation to quickly breach and remove obstacles, to facilitate law enforcement officers to enter a structure.

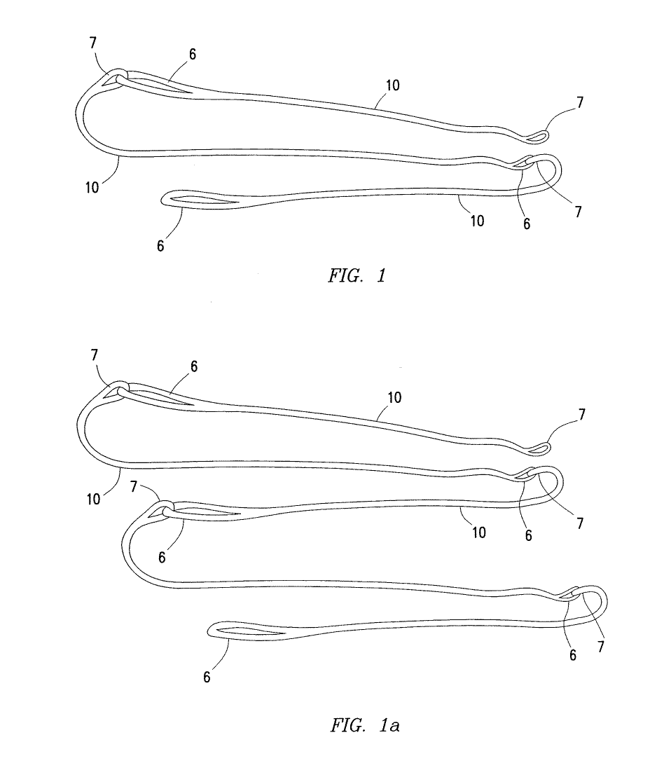

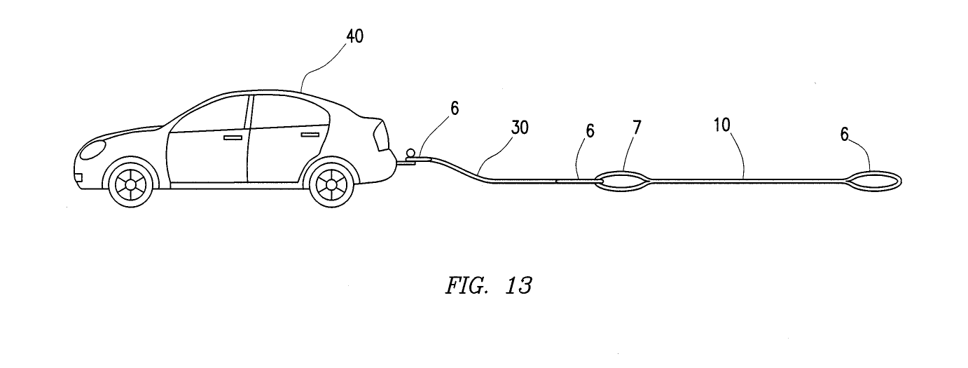

In embodiments as illustrated in FIGS. 1-12, a breach sling system 5 comprises a rope 10, a deployment bag 15, a carry bag 20, and a breaching hook 25. In an embodiment, breach sling system 5 may include a plurality of ropes 10. Ropes 10 may be attached to one another, providing the breach sling system 5 with a greater reach. Any number of ropes 10 may be attached to each other. In embodiments, there may be two, three, four, five, six, seven, eight, nine, and/or ten ropes 10, with each attached to another rope10. As illustrated in FIG. 1, each rope 10 may have a large loop 6 at one end of rope 10 and a small loop 7 at the opposing end of rope 10. Rope 10 may attach to an adjacent rope 10 through small loop 7, which may attach to a large loop 6 on an adjacent rope 10. The use of a small loop 7 at one end and large loop 6 at the opposing end of rope 10 allows the user to quickly identify large loop 6 and attach large loop 6 to a breaching hook 25 and/or a vehicle 40. In embodiments, as illustrated in FIG. 13, a lead rope 30 may connect rope 10 to a vehicle 40. Lead rope 30 may have two large loops 6 at each opposing end. This may allow lead rope 30 to attach to a small loop 7 of an adjacent rope 10, while allowing a large loop 6 to be available for attachment to a vehicle 40.

A rope 10 may be about six feet to about twelve feet, about eight feet to about ten feet, about nine feet to about twelve feet, and/or about six feet to about ten feet in length. In embodiments, rope 10 may be about six feet, about seven feet, about eight feet, about nine feet, about ten feet, about eleven feet, or about twelve feet in length. Rope 10 may be made of any suitable non-kinetic material. Suitable material may be, but is not limited to nylon, polypropylene, fabric, neoprene, leather, plastic, or any combination thereof. Non-kinetic material may prevent rope 10 from snapping and/or thrashing back when rope 10 may break. When in use, rope 10 may connect breaching hook 25 to a vehicle 40. A vehicle 40 may pull breaching hook 25 using rope 10. In the event that rope 10 breaks, non-kinetic material may prevent rope 10 from snapping back and potentially hurting individuals around rope 10. When materials or items are removed, the tension along rope 10 is released upon movement of the materials or items. This may prevent rope 10, the material, and/or items from whipping, snapping, or thrashing back toward personnel and/or vehicles 40.

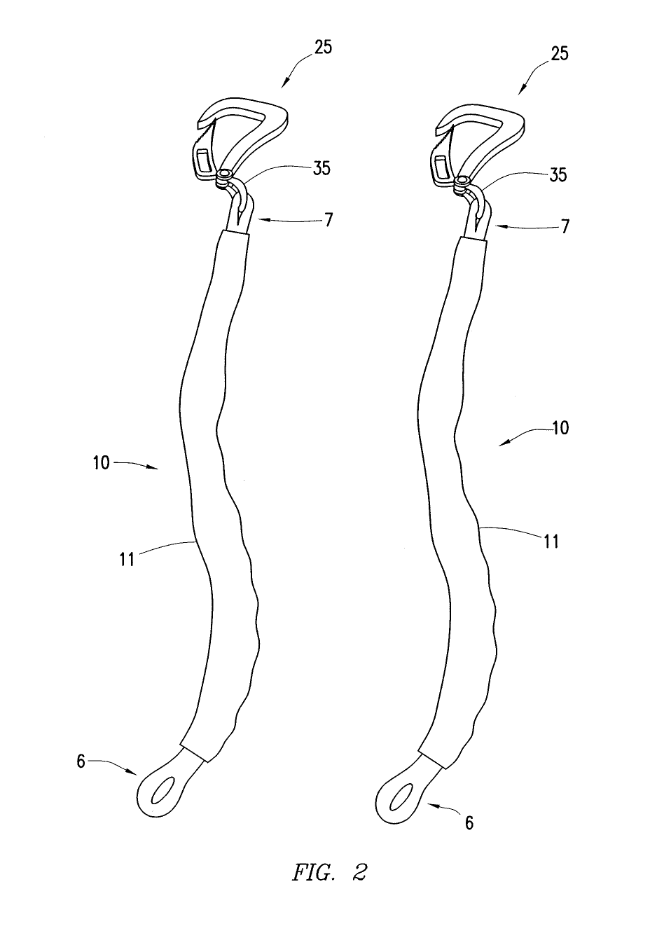

In embodiments, as illustrated in FIG. 2, a sleeve 11 may traverse about the length of rope 10 with rope 10 substantially disposed therein. In alternative embodiments, not illustrated, a portion of rope 10 may be disposed within sleeve 11. Small loop 7 and large loop 6 may also be covered by sleeve 11. Sleeve 11 may be made of any suitable material. Suitable material may be, but is not limited to, nylon, Kevlar® (Kevlar is a Trademark and commercially available from E. I. du Pont de Nemours and Company), Nomex® (Nomex is a Trademark and commercially available from E.I. du Pont de Nemours and Company), or any combination thereof. Without limitation, the material in sleeve 11 may protect rope 10 from being cut, burned, and/or from deteriorating from exposure to external elements.

As described above, rope 10 may attach to another rope 10 by attaching small loop 7 of a rope 10 to a large loop 6 of an adjacent rope 10. In embodiments, small loop 7 may be linked to large loop 6 during manufacturing, as illustrated in FIG. 1a. There may be a plurality or ropes 10 attached to each other. As illustrated in FIG. 1a, there may be five ropes 10 attached to each other. In embodiments, adjacent ropes 10 are permanently attached to each other and may not be separated. In embodiments, a small loop 7 may tie to large loop 6, or small loop 7 may attach to large loop 6 by any suitable means. Suitable means may include, but are not limited to, shackles, fasteners, straps, carabineers, rings, links, and/or the like. Connection methods may allow individual ropes 10 to be removed and/or added. Breaching hook 25 may attach to a rope 10 furthermost away from lead rope 30. Breaching hook 25 may attach to rope 10 through large loop 6 by any suitable means. As illustrated in FIG. 2, breaching hook 25 may attach to large loop 6 by a shackle 35. Other suitable means may include, but are not limited to, snap fittings, tethers, carabineers, clasp, or any combination thereof. In embodiments, breaching hook 25 may be welded or connected directly to breaching hook 25, making rope 10 and breaching hook 25 one contiguous piece.

Breaching hook 25 may be used for attachment to materials or items that are desired to be removed for entry into a structure. Examples of a material or item may be a door, burglar bars, walls, windows, columns, and/or the like. In embodiments, breaching hook 25 may be made of any suitable material. Suitable material may be, but is not limited to, steel, stainless steel, black iron, A514 carbon steel, plastic, titanium, or any combination thereof. In many current applications, breaching hooks 25 are not used because the hook may bend under the tension and force exerted by the materials on the hook. This may cause the hook to fail, deform, or bend, which may cause breaching hook 25 to release the materials or items designated for removal.

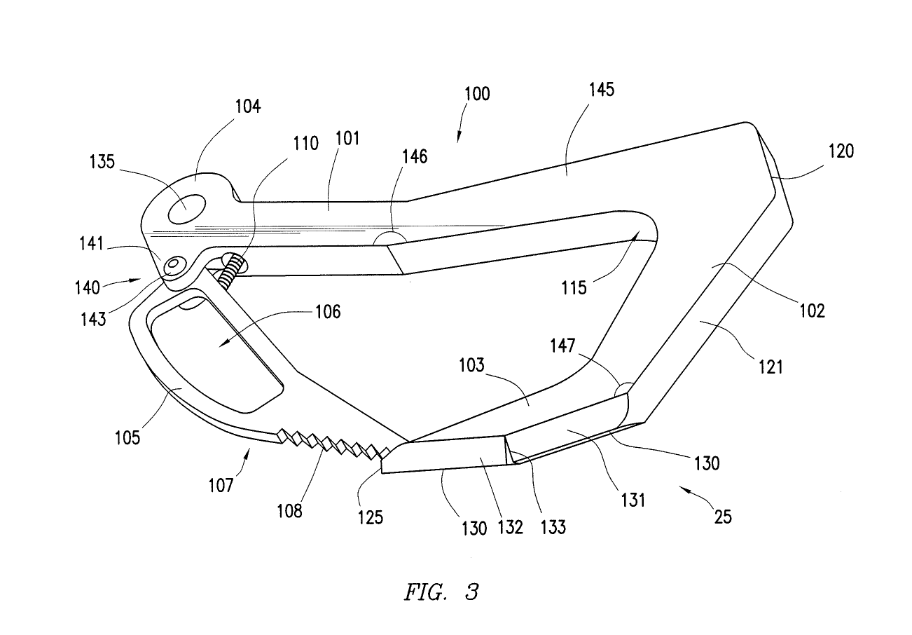

In embodiments illustrated in FIG. 3, to prevent failure, breaching hook 25 may comprise a main member 100, a gate 105, a spring 110, and a pin 143. As illustrated in FIG. 3, main member 100 may have a vertical member 101, upper member 102, pointed member 103, and connection member 104. Vertical member 101 may be of any suitable shape. A suitable shape may be square, rectangular, circular, polyhedral, or any combination thereof. In embodiments, vertical member 101 may have a width about one centimeter to about ten centimeters, about two centimeters to about eight centimeters, about four centimeters to about six centimeters, and/or about five centimeters to about ten centimeters. Vertical member 101 may have a depth about one centimeter to about ten centimeters, about two centimeters to about eight centimeters, about four centimeters to about six centimeters, and/or about five centimeters to about ten centimeters. Vertical member 101 may have a length about one inch to about twenty four inches, about four inches to about twenty two inches, about six inches to about twenty inches, about eight inches to about eighteen inches, about ten inches to about sixteen inches, about twelve inches to about fourteen inches, and/or about twelve inches to about twenty four inches.

In embodiments, vertical member 101 may be straight or angled. In embodiments, as illustrated in FIG. 3, vertical member 101 may begin straight and then angle away from pointed member 103. Vertical member 101 may be straight for about one inch to about twelve inches, about two inches to about ten inches, about four inches to about eight inches, about six inches to about twelve inches, and/or about one inch to about six inches. An angled member 101 may connect to vertical member 101, as illustrated in FIG. 3. Angled member 101, at angle 146, may angle away from pointed member 103 at about ten degrees to about forty five degrees, about fifteen degrees to about forty degrees, about twenty degrees to about thirty degrees, about twenty five degrees to about thirty three degrees, and/or about thirty degrees to about forty five degrees. Furthermore, as angled member 145 angles away from pointed member 103, the width and depth of angled member 145 may increase, as illustrated in FIG. 3. The angle 146 of angled member 145 may allow breaching hook 25 to grip large objects, which may be accomplished from the increase in space formed due to the angling of angled member 145.

In embodiments, upper member 102 may be connected to vertical member 101 and pointed member 103. As illustrated in FIG. 3, upper member 102 may be of any suitable shape. A suitable shape may be square, rectangular, circular, polyhedral, or any combination thereof. In embodiments, upper member 102 may have a width about one centimeter to about ten centimeters about two centimeters to about eight centimeters, about four centimeters to about six centimeters, and/or about five centimeters to about ten centimeters. Upper member 102 may have a depth about one centimeter to about ten centimeters, about two centimeters to about eight centimeters, about four centimeters to about six centimeters, and/or about five centimeters to about ten centimeters. Upper member 102 may have a length about one inch to about twenty four inches, about four inches to about twenty two inches, about six inches to about twenty inches, about eight inches to about eighteen inches, about ten inches to about sixteen inches, about twelve inches to about fourteen inches, and/or about twelve inches to about twenty four inches.

Upper member 102 and vertical member 101 may form a pocket 115. Pocket 115 may be formed at the intersection of upper member 102 and vertical member 101. Pocket 115 may be any suitable shape to grip material and objects. A suitable shape may be circular, square, triangular, polyhedral, or any combination thereof. Pocket 115 may allow breaching hook 25 to fit around materials and items, which may prevent breaching hook 25 from slipping off material. As illustrated in FIG. 3, upper member 102 may have two faces 120 and 121. Faces 120 and 121 may be flat, allowing a user to create space within material and items for pointed member 103 to pass through unobstructed.

Pointed member 103 may attach to upper member 102. As illustrated in FIG. 3, pointed member 103 may be of any suitable shape. A suitable shape may be square, rectangular, triangular, circular, polyhedral, or any combination thereof. In embodiments, pointed member 103 may have a width about one centimeter to about ten centimeters, about two centimeters to about eight centimeters, about four centimeters to about six centimeters, and/or about five centimeters to about ten centimeters. Pointed member 103 may have a depth about one centimeter to about ten centimeters, about two centimeters to about eight centimeters, about four centimeters to about six centimeters, and/or about five centimeters to about ten centimeters. Pointed member 103 may have a length about one inch to about twenty-four inches, about four inches to about twenty-two inches, about six inches to about twenty inches, about eight inches to about eighteen inches, about ten inches to about sixteen inches, about twelve inches to about fourteen inches, and/or about twelve inches to about twenty four inches.

Extending from upper member 102, pointed member 103 may reduce in width and depth to form a point 125. As illustrated in FIG. 3, pointed member 103 may extend away from upper member 102 forming an angle 147 in relation to upper member 102. Angle 147 may be formed between upper member 102 and pointed member 103 at about ten degrees to about one hundred and seventy degrees, about ten degrees to about one hundred and seventy degrees, about twenty degrees to about one hundred and sixty degrees, about thirty degrees to about one hundred and fifty degrees, about thirty five degrees to about one hundred and forty degrees, about forty degrees to about one hundred and thirty five degrees, about forth five degrees to about one hundred and thirty degrees, about fifty degrees to about one hundred and twenty degrees, about sixty degrees to about one hundred and ten degrees, about seventy degrees to about on hundred degrees, and/or about eighty degrees to about ninety degrees.

Pointed member 103 may comprise two angled faces 131 and 132, which may have an edge 130, as illustrated in FIG. 3. Faces 131 and 132 may angle away from each other at angle 133. Angle 133 may be about ten degrees to about forty-five degrees, about fifteen degrees to about forty degrees, about twenty degrees to about thirty degrees, about twenty five degrees to about thirty-three degrees, and/or about thirty degrees to about forty-five degrees. Faces 131 and 132 may allow for removal of material using edge 130. In embodiments, edge 130 may be triangular. In embodiments, there may be a plurality of edges 130. Edge 130 may extend out from faces 131 and 132 at about half a centimeter to about five centimeters, about two centimeters to about eight centimeters, about four centimeters to about six centimeters, and/or about five centimeters to about ten centimeters. Edge 130 may allow breaching hook 25 to act as a cutting instrument that a user may use to cut through material or items in order to clear a path, which may allow breaching hook 25 to securely attach to materials or items.

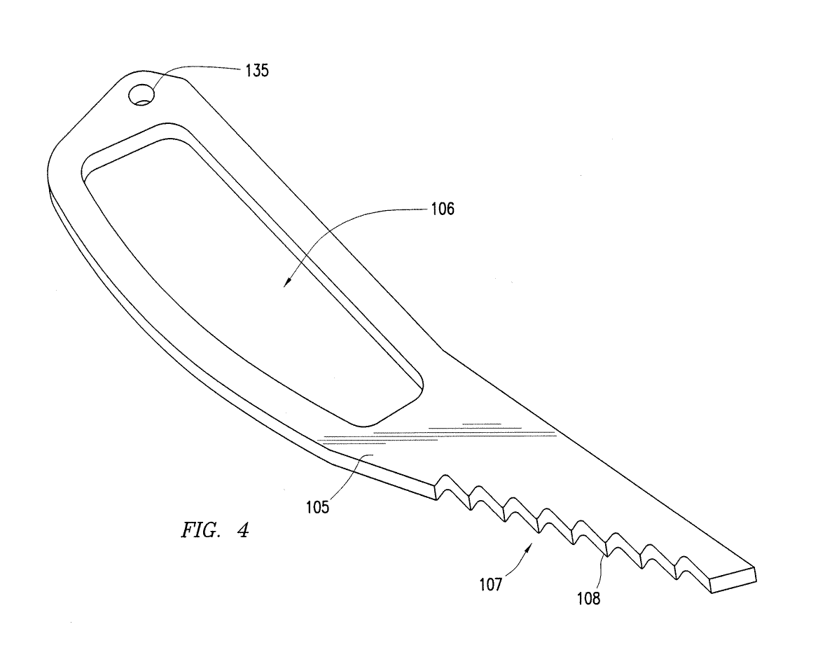

Breaching hook 25 may have a gate 105, as illustrated in FIGS. 3 and 4, to create a closed loop with vertical member 101, upper member 102, and pointed member 103 when in the closed position as shown. Gate 105 may be of any suitable shape. A suitable shape may be square, rectangular, circular, polyhedral, or any combination thereof. In embodiments, gate 105 may have a width from about one centimeter to about ten centimeters, about two centimeters to about eight centimeters, about four centimeters to about six centimeters, and/or about five centimeters to about ten centimeters. Gate 105 may have a depth about one centimeter to about ten centimeters, about two centimeters to about eight centimeters, about four centimeters to about six centimeters, and/or about five centimeters to about ten centimeters. Gate 105 may have a length about one inch to about twenty-four inches, about four inches to about twenty-two inches, about six inches to about twenty inches, about eight inches to about eighteen inches, about ten inches to about sixteen inches, about twelve inches to about fourteen inches, and/or about twelve inches to about twenty four inches. Gate cut-out 106 may be any suitable shape. A suitable shape may be square, rectangular, circular, polyhedral, or any combination thereof. Gate cut-out 106 may allow users to place their fingers within gate cut-out 106, which may allow a user to grasp vertical member 101 with the palm and thumb of their hand. By closing the hand into a fist, a user may open gate 105, allowing breaching hook 25 to attach to material and items. When the user opens their hand, gate 105 is pushed back toward pointed member 103 through force exerted by spring 110 on gate 105. Gate 105 may come to rest, or is stopped, on pointed member 103. While resting against pointed member 103, gate 105 may prevent materials or items from disengaging breaching hook 25.

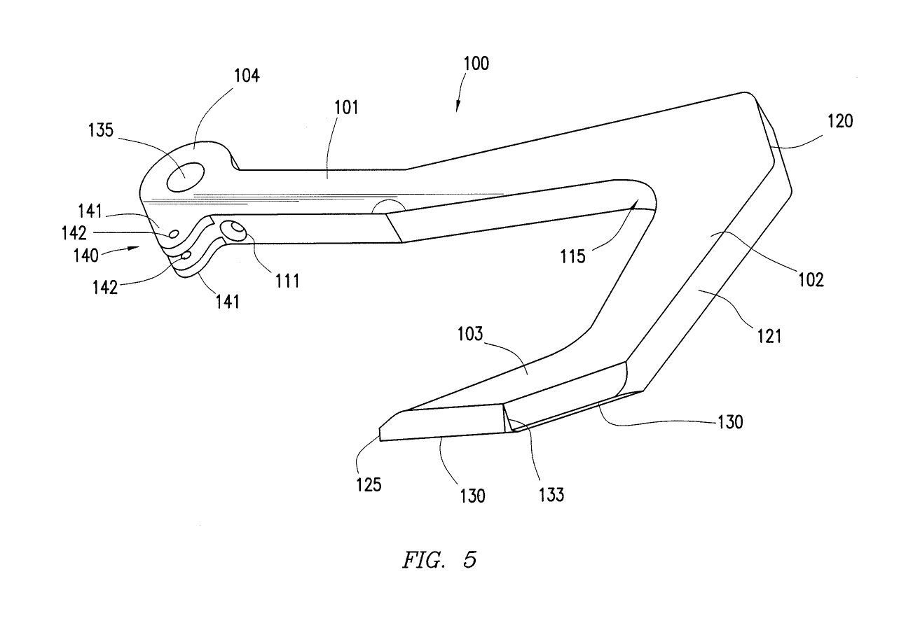

Gate 105 may attach to breaching hook 25 at connection member 104. Connection member 104 may attach at the end of vertical member 101 opposite of upper member 102. Connection member 104 may attach breaching hook 25 to rope 10. Connection member 104, as illustrated in FIGS. 3 and 5, may be any suitable shape. Suitable shapes may be circular, square, rectangular, polyhedral, or any combination thereof. Connection member 104 may have any width about one centimeter to about ten centimeters, about two centimeters to about eight centimeters, about four centimeters to about six centimeters, and/or about five centimeters to about ten centimeters. Connection member 104 may have a depth about one centimeter to about ten centimeters, about two centimeters to about eight centimeters, about four centimeters to about six centimeters, and/or about five centimeters to about ten centimeters. Connection member 104 may have a length about one centimeter to about five centimeters, about one centimeter to about three centimeters, about three centimeters to about five centimeters, and/or about two centimeters to about four centimeters. Connection member 104 may have cut-out 135, which may be used to attach connection member 104 to rope 10 or any other suitable structure.

In embodiments, as illustrated in FIGS. 3 and 5, cut-out 135 may be any suitable shape. A suitable shape may be circular, square, rectangular, polyhedral, or any combination thereof. Cut-out 135 may pass completely through connection member 104. In embodiments, cut-out 135 may be threaded to accept bolts and not pass completely through connection member 104. Cut-out 135 may allow pins, nuts and bolts, shackles, screws, or the like to attached connection member 104 to rope 10. As illustrated in FIGS. 3 and 5, connection member 104 may further have gate attachment 140. Gate attachment 140 may attach to connection member 104 by any suitable means. Suitable means may include, but is not limited to, welding, formed as a single piece, nuts and bolts, screws, adhesive, or any combination thereof. Gate attachment 140 may comprise two pillars 141, which oppose each other. Each pillar may have a pin hole 142 in which a pin 143 may be used to attach gate 105 to breaching hook 25. Using pin 143 may allow for gate 105 to rotate about pin 143 freely. This may allow for material to pass through gate 105 to the center of breaching hook 25. Gate 105 may close with the assistance of spring 110. As illustrated in FIG. 3, spring 110 may attach to vertical member 101 and gate 105. As illustrated in FIG. 5, vertical member 101 may have a spring cut-out 111, which may be a depression that may sink into vertical member 101 and which may allow spring 110 to push off of vertical member 101 and exert force upon gate 105. Gate 105 may have a similar depression or spring mount, which may allow spring 110 to attach to gate 105. This mount may prevent spring 110 from slipping off gate 105 as spring 110 exerts force upon gate 105.

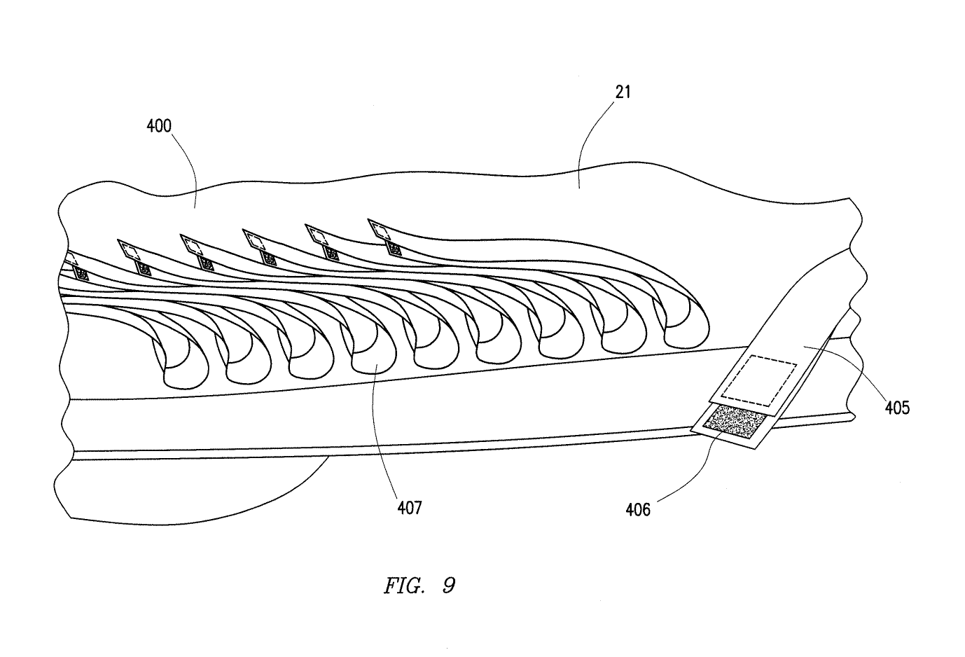

As illustrated in FIGS. 3 and 9, gate 105 may have a serrated edge 107 with a plurality of teeth 108. Teeth 108 may be angled toward pointed member 103. Serrated edge 107 may be used when breaching hook 25 is placed around material and items that are larger than the area within breaching hook 25. When larger material and items are hooked by breaching hook 25, gate 105 may be pressed against vertical member 101. Gate 105 may not be able to return to pointed member 103 due to the force exerted on gate 105 by larger material and items. Serrated edge 107 may attach gate 105 to larger material or items. With the plurality of teeth 108 angled toward pointed member 103, teeth 108 may dig into larger material or items. This may prevent larger material or items from disengaging breaching hook 25, which may be effective against softer material and small items. Gate 105 may allow breaching hook 25 to secure smaller materials and items, which ordinary hooks may have trouble attaching thereto. Furthermore, serrated edge 107 may allow breaching hook 25 to grip softer materials, which ordinary hooks may not grip.

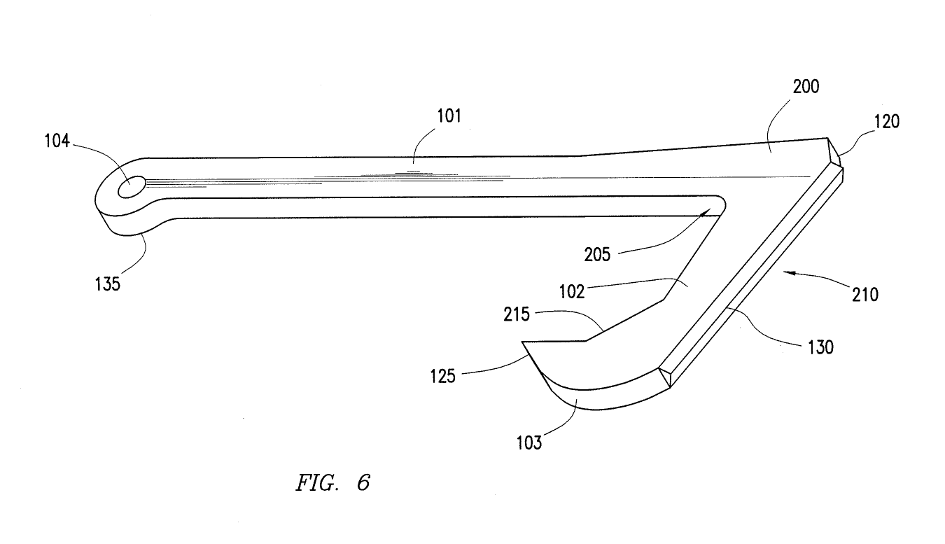

In embodiments, breaching hook 25 may not utilize gate 105. As illustrated in FIG. 6, breaching hook 25 may comprise a vertical member 101, an upper member 102, a pointed member 103, a point 125, a connection member 104, and a cut-out 135. In embodiments, vertical member 101 may further comprise reinforcement member 200. As illustrated in FIG. 6, reinforcement member 200 may angle away from pointed member 103 along vertical member 101 to upper member 102. This may increase the strength of vertical member 101 and upper member 102. Without limitation, this may prevent the breaking or straightening at the connection point of vertical member 101 and upper member 102, when exposed to the amount of force exerted upon the breaching hook by materials and items. Reinforcement member 200 may increase the mass and strength of breaching hook 25, preventing breaching hook 25 from breaking, collapsing, or straightening during operation.

A pocket 205 may further comprise the connection point of upper member 102 and vertical member 101. Pocket 205 may be any suitable shape to grip materials and items. A suitable shape may be circular, square, triangular, polyhedral, or any combination thereof. Pocket 205 may allow breaching hook 25 to grip materials and items, preventing breaching hook 25 from slipping. Upper member 102 may further comprise outer face 210 which may traverse the length of upper member 102. In embodiments, outer face 210 may have edge 130. Edge 130 may traverse the length of outer face 210. A sharp edge 130 may allow the user to cut and clear an area around materials or items, allowing the user to place breaching hook 25 around chosen materials or items.

Support section 215, illustrated in FIG. 6, in embodiments is disposed between upper member 102 and pointed member 103. Support section 215 may form an angle between upper member 102 and pointed member 103 of about ten degrees to about ninety degrees, about twenty degrees and eighty degrees, about thirty degrees and seventy degrees, about forty degrees and about sixty degrees, about fifty degrees and ninety degrees, and/or about thirty degrees and about seventy degrees. Support section 215 mat provide additional strength to upper member 102 and pointed member 103. Furthermore, support section 215 may create angles designed to catch and grip materials or items. This may prevent materials and items from slipping off breaching hook 25. Additionally, support section 215 may catch and prevent materials or items from breaking pointed member 103 and/or slipping off pointed member 103. In embodiments, pointed member 103 may be rounded, triangular, cylindrical, square, rectangular, or any combination thereof. This may increase the mass and structural strength of pointed member 103, which may prevent pointed member 103 from breaking or straightening during use.

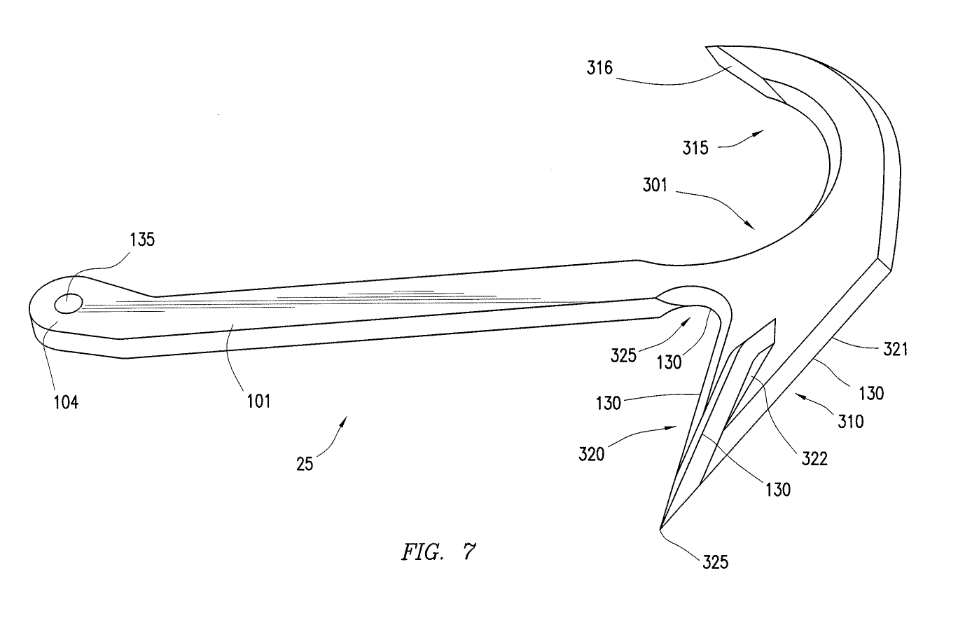

As illustrated in FIG. 7, in embodiments, breaching hook 25 may comprise a wedge member 315, a breaching member 310, a vertical member 101, a cross member 301, a connection member 104, and a cut-out 135. Cross member 301 may comprise a breaching member 310 and a wedge member 315. Breaching member 310 may further comprise a bottom face 320 and a top face 321. Edge 130 may traverse the length of both bottom face 320 and top face 321. Edge 130, as described above, may remove obstructions and clear space around materials or items a user wishes to grip with breaching hook 25. Bottom face 320 and top face 321 may come to a point 325. Point 325 may allow for breaching hook 25 to break through material or lodge breaching hook 25 into items, obstacle, or materials that the user wishes to remove. Bottom face 320, with edge 130 may connect to vertical member 101, forming a pocket 325. Pocket 325 may be any suitable shape to allow breaching hook 25 to grasp material and items. A suitable shape may be circular, square, rectangular, polyhedral, or any combination thereof. Edge 130 may traverse pocket 325, as illustrated in FIG. 7, allowing the user to grip material and items with pocket 325 and then cut, break, or remove that material or item with edge 130.

Point 325 may further comprise a plurality of flares 322. In embodiments, flare 322 may be on each side of breaching member 310. As illustrated in FIG. 7, flares 322 may be flush with point 325 but extend in height as flare 322 moves away from point 325. Flares 322 may further comprise edge 130, which may allow flares 322 to act as a spade, wherein flares 322 help cut through material and items but may also help “shovel” away the material and items that have been removed. This action may help the user clear an area more efficiently.

Wedge member 315 may be on the end of cross member 301 opposite breaching member 310. Wedge member 315 may be of any suitable shape to allow breaching hook 25 to pry materials and items away from an area. Suitable shapes may be, but is not limited to circular, triangular, polyhedral, square, rectangular, or any combination thereof. Wedge member 315 may further be straight or radially bent, as illustrated in FIG. 7. Wedge member 315 may have an edge 316 that may be furthermost away from breaching member 310, forming an angle along wedge member 315. The formed angle may be about ten degrees to about one hundred and seventy degrees. In embodiments, the angle may be about ten degrees to about one hundred and seventy degrees, about ten degrees to about one hundred and seventy degrees, about twenty degrees to about one hundred and sixty degrees, about thirty degrees to about one hundred and fifty degrees, about thirty five degrees to about one hundred and forty degrees, about forty degrees to about one hundred and thirty five degrees, about forty-five degrees to about one hundred and thirty degrees, about fifty degrees to about one hundred and twenty degrees, about sixty degrees to about one hundred and ten degrees, about seventy degrees to about one hundred degrees, and/or about eighty degrees to about ninety degrees. Edge 316 may act as a wedge, which may allow a user to leverage edge 316 against material, prying materials and items apart. In embodiments, edge 316 and wedge member 315 may act as a hook, allowing a user to hook on to materials or items.

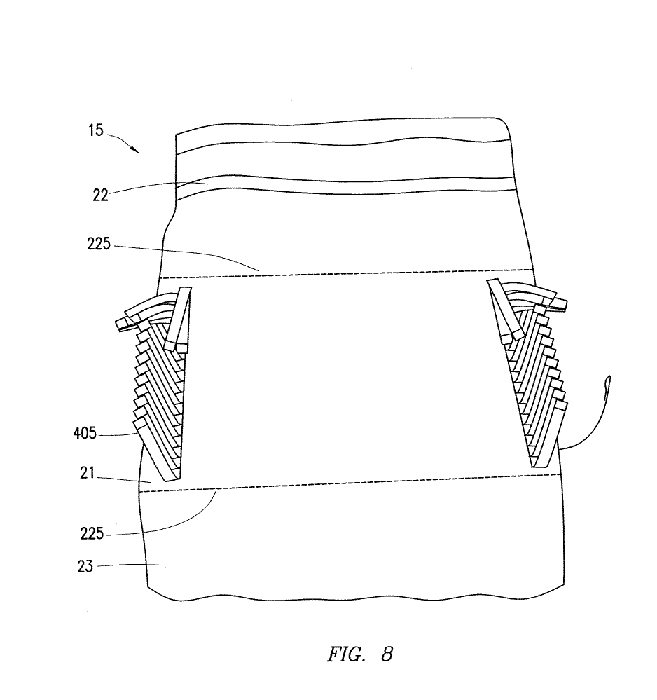

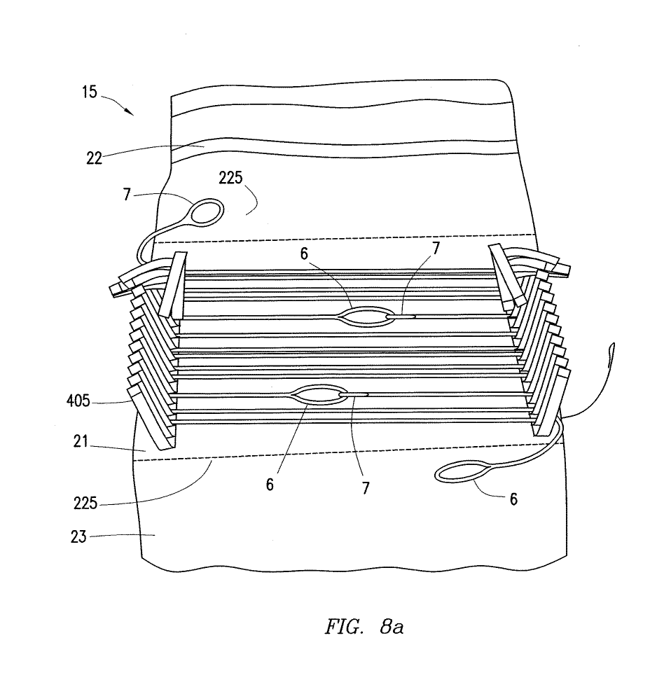

In embodiments, breaching hook 25 may be transported, housed, and implemented using deployment bag 15 while attached to rope 10. As illustrated in FIGS. 8-10, deployment bag 15 may be made of any suitable material. Suitable material may be, but is not limited to, cloth, plastic, cotton, faux fur, leather, suede, linen, polyesters, rayon, silk, tapestry, velvet, velveteen, lining fabrics, or any combinations thereof. As illustrated in FIG. 8, deployment bag 15 may comprise an inner compartment 21, a securing wall 22, and an outer wall 23. Inner compartment 21, securing wall 22, and outer wall 23 may be flat and further comprise inner cushioning. Inner cushioning, not illustrated, may add additional protection to rope 10 and breaching hook 25 to prevent wear and tear from external elements. In embodiments, inner compartment 21, securing wall 22, and outer wall 23 may be attached to each other through a flexible connection 225, illustrated in FIGS. 8-10. Flexible connection 225 may allow for securing wall 22 to fold over inner compartment 21, and for outer wall 23 to fold over securing wall 22. Flexible connection 225 may be made of any suitable material. Suitable material may include, but is not limited to, rubber, polyesters, fabric, or any combination thereof. A handle 24 may attach to flexible connection 225, which may attach inner compartment 21 to outer wall 23. Handle 24 may be made of any suitable material. Suitable material may be, but is not limited to webbing, cloth, plastic, cotton, faux fur, leather, suede, linen, polyesters, rayon, silk, tapestry, velvet, velveteen, lining fabrics, or any combinations thereof. Handle 24 may attach to flexible connection 225 by any suitable means. Suitable means may be, but are not limited to, stitching, button, fasteners, adhesive, or any combination thereof.

In embodiments, inner compartment 21 may have a plurality of restraint loops 405. As illustrated in FIG. 9, restraint loops 405 may comprise a length of material, which may further comprise a connection means 406 at an end of the material. Connection means 406 may be used to form restraint loop 405 while in use. While not in use, connection means 406 may be undone, allowing for the insertion of rope 10 within connection means 406. Connection means 406 may comprise, but are not limited to, hook and loop, buttons, clasps, buckles, threading, or any combination thereof. Restraint loop 405 may be used to restrain rope 10, preventing entanglement. Restraint loop 405 may be made of any suitable material. Suitable material may be, but is not limited to, webbing, cloth, plastic, cotton, faux fur, leather, suede, linen, polyesters, rayon, silk, tapestry, velvet, velveteen, lining fabrics, or any combinations thereof. Restraint loop 405 may be of any suitable length in which to restrain rope 10. Suitable length may be about half an inch to about twelve inches, about two inches to about ten inches, about four inches to about eight inches, about six inches to about twelve inches, and/or about one inch to about six inches. A connection point 407 of restraint loop 405 may secure restraint loop 405 to inner compartment 21 by any suitable means. Suitable means may be, but are not limited to stitching, button, fasteners, adhesive, or any combination thereof.

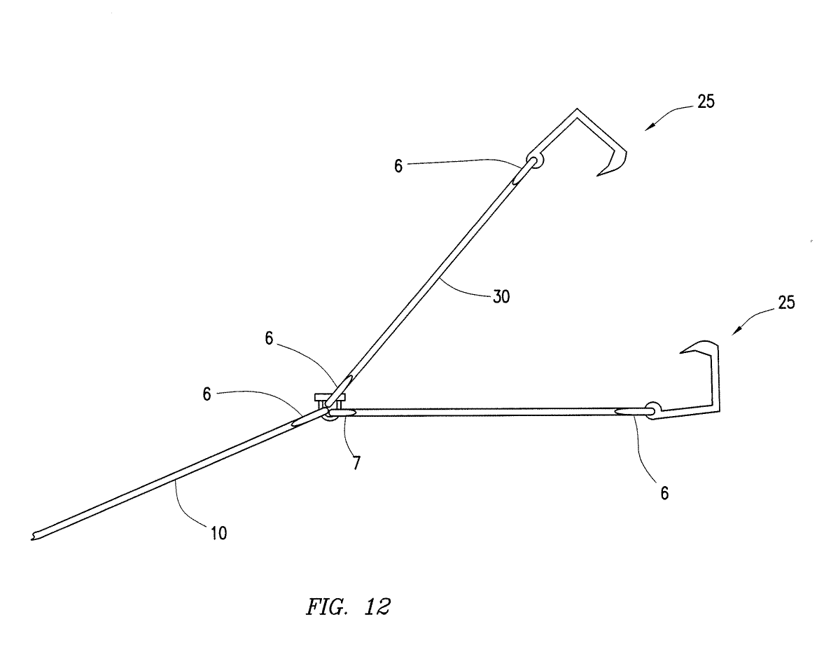

As illustrated in FIGS. 8 and 9, there may be a plurality of rows that have a plurality of restraint loops 405. In embodiments, rope 10 may be held in place for deployment by restraint loops 405. Restraining rope 10 may include rope 10 to be secured to a restraint loop 405 in one row, then secured to the opposing restraint loop 405 in an opposing row. Rope 10 may pass from one row to the other, back and forth, traversing either up or down inner compartment 21. This “S” pattern may allow rope 10 to be secured and readied for deployment while preventing the entanglement of rope 10. In embodiments, as illustrated in FIG. 12, lead rope 30 may further be attached to a plurality of ropes 10 within inner compartment 21, held to inner compartment 21 by restraint loops 405. Lead rope 30 may further have a free large loop 6, where large loop 6 may be secured to outer wall 23 of carry bag 20. This may allow a user to rapidly attach lead rope 30 to a vehicle 40. Furthermore, rope 10 may have a separate large loop 6 which is secured to breaching hook 25, wherein breaching hook 25 is secured to the outside of inner compartment 21.

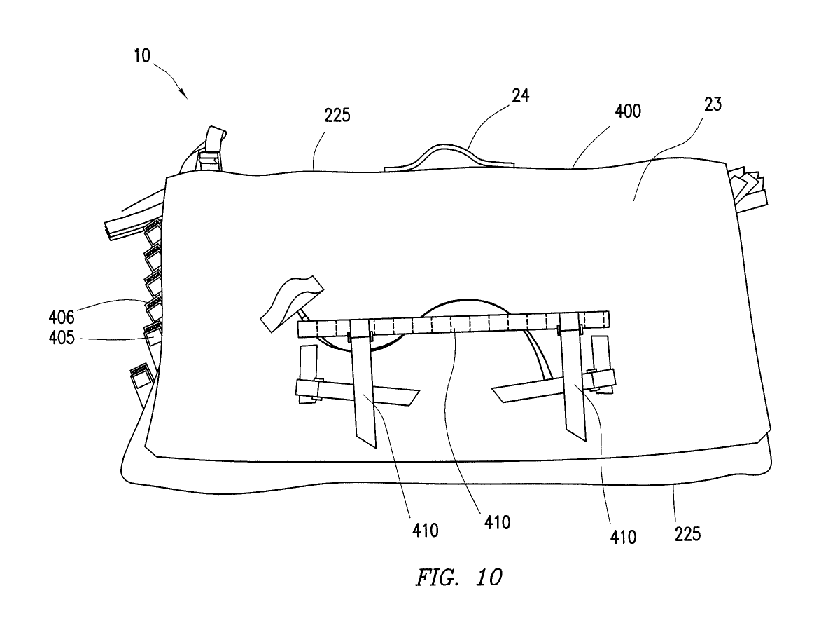

In embodiments, rope 10 is secured to inner compartment 21 as illustrated in FIG. 8a. Once secured, securing wall 22 is folded over inner compartment 21, not illustrated, enclosing rope 10 and lead rope 30 within a confined area defined by inner compartment 21 and securing wall 22. Securing wall 22 may latch to inner compartment 21 by latching means 26, holding securing wall 22 in position for deployment. Latching means 26 may include, but is not limited to, hook and loop, latch, string, webbing, latch, or any combination thereof. Latching means 26 may traverse the length of securing wall 22. In embodiments, latching means 26 may be about one inch to about twenty four inches long, about four inches to about twenty inches, about six inches to about eighteen inches, eight inches to about sixteen inches, about ten inches to about fourteen inches, and/or about twelve inches to about twenty-four inches. Latching means 26 may have a width of about half a centimeter to about ten centimeters, about two centimeters to about eight centimeters, about four centimeters to about six centimeters, and/or about five centimeters to about ten centimeters. Outer wall 23 may fold over securing wall 22, enclosing securing wall 22 between inner compartment 21 and outer wall 23. Outer wall 23 may latch to securing wall 22 by any suitable means, allowing outer wall 23 to provide structure support for deployment bag 15. As illustrated in FIG. 10, breaching hook 25 may be secured to outer wall 23 on the outside of deployment bag 15. Breaching hook 25, while attached to rope 10, is secured to loop webbing 410. Loop webbing 410 may be made of any suitable material. Suitable material may be, but is not limited to, webbing, cloth, plastic, cotton, faux fur, leather, suede, linen, polyesters, rayon, silk, tapestry, velvet, velveteen, lining fabrics, or any combinations thereof. Loop webbing 410 may be secured to outer wall 23 in a plurality of connection points 407. Rip cord 415 may be secured to breaching hook 25 by loop webbing 410. During deployment, a user may pull rip cord 415, releasing breaching hook 25 from loop webbing 410.

Deployment bag 15 may be contained within carry bag 20. Carry bag 20 may house deployment bag 15, allowing a user to store and move breach sling system 5 with relative ease. Carry bag 20 may further conceal deployment bag 15 and breach sling system 5. This may allow law enforcement personnel to deploy breach sling system 5 in a discrete matter without being noticed. In embodiments, carry bag 20 may be used in conjunction with deployment bag 15. Carry bag 20 may transport and/or store deployment bag 15 when deployment bag 15 is not in use. Carry bag 20 may prevent the deterioration of deployment bag 15, ropes 10, and breaching hook 25 from excessive wear and tear caused by external elements. In embodiments, not illustrated, carry bag 20 may house only rope 10 and/or a plurality of ropes 10. This may allow for a user to transport and/or deploy ropes 10 without deployment bag 15. Using ropes 10 and carry bag 20, a user may approach an object and attach breaching hook 25 to the object. The user may then take rope 10 and/or ropes 10 from carry bag 20 and connect the ropes 10 to breaching hook 25 by any suitable means. Suitable connection means may be shackle 35, a carabineer, and/or any combination. Connection means are not limited to shackle 35 and/or a carabineer, but may include other connection means. The user may then connect ropes 10 to a vehicle 40 through lead rope 30. Vehicle 40 may then pull away from the object, removing the object by force through ropes 10 and breaching hook 25.

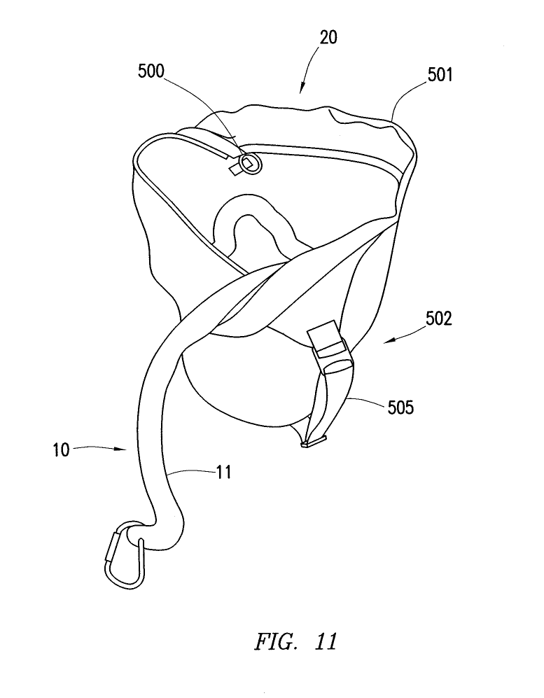

As illustrated in FIG. 11, carry bag 20 may be made of any suitable material. Suitable material may be, but is not limited to, cloth, canvas, plastic, polyesters, webbing, fabric, or any combination thereof. Carry bag 20 may be any suitable shape. A suitable shape may be cylindrical, square, rectangular, polyhedral, or any combination thereof. In embodiments, carry bag 20 may be any suitable length. A suitable length me be about one foot to about six feet, about two feet to about four feet, about three feet to about six feet, and/or about one foot to about three feet. As illustrated in FIG. 11, carry bag 20 may have an open end 501 and a closed end 502. A drawstring 500 may traverse the circumference of open end 501. Drawstring 500 may be concealed and/or encircled by material that runs along the circumference of open end 501. Drawstring 500 may be used to open and close open end 501. It is to be understood carry bag 290 is not limited to drawstring 500 but may have any other suitable means for opening and closing open end 501. A shoulder strap 505 may attach to carry bag 20. Shoulder strap 505 may be made of any suitable material. Suitable material may be, but is not limited to, cloth, canvas, plastic, webbing, fabric, or any combination thereof. In embodiments, shoulder strap 505 may traverse the length of carry bag 20 and attach to carry bag 20 at two connection points 507. Shoulder strap 505 may traverse about one foot to about six feet, about two feet to about four feet, about three feet to about six feet, and/or about one foot to about three feet of carry bag 20. In embodiments, shoulder strap 505 may be adjustable, allowing the user to adjust how carry bag 20 is slung over the user's shoulder.

Carry bag 20 may be discrete, so as to not draw attention to the user. A user may deploy rope 10 and lead rope 30 from within carry bag 20. This may allow the user to have an element of surprise. The simple design and use of a drawstring 500 may allow a user to remove rope 10 with ease, allowing the user to speedily deploy breaching hook 25. In embodiments, deployment bag 15 and/or carry bag 20 may be attached to a vehicle 40. During deployment, the user may attach large loop 6 of lead rope 30 to a vehicle hitch, a modified hook on vehicle 40, a bumper, and/or any other suitable structure on vehicle 40. Lead rope 30 may attach to any side of vehicle 40, such as the front, back, sides, top, or bottom of vehicle 40. The user may then attach breaching hook 25 to lead rope 30 (if not previously attached) and then deploy breaching hook 25 and attach it to any material or item the user wishes to remove. During deployment of breaching hook 25, rope 10 may begin to unwind from deployment bag 15. In embodiments in which employment bag 15 is attached to vehicle 40, as rope 10 unwinds from deployment bag 15, outer wall 23 and securing wall 22 are unlatched by the user and/or by the force exerted on rope 10 by breaching hook 25. As the user carries breaching hook 25 to the desired object, the other ropes 10 are pulled from deployment bag 15 and/or carry bag 20 until breaching hook 25 is attached to the desired object. When breaching hook 25 is attached to the desired object, large loop 6 of rope 10 deployed proximate vehicle 40 is attached to vehicle 40. Such proximate rope 10 may be attached to vehicle 40 by any suitable means such as by a carabineer. Vehicle 40 may then pull away and remove the desired object. The tension pulls breaching hook 25, which is secured to the material or item, eventually placing enough force on the material or item to remove the material or item from its original position.

At times, certain material or items may need a plurality of breaching hooks 25 to properly remove the material or item. As illustrated in FIG. 12, a user may attach a shackle 35 to any large loop 6 along rope 10. An additional lead rope 30 may attach to shackle 35. In embodiments, an additional shackle 35 may be attached, adding an addition lead rope 30. The user may attach a breaching hook 25 to the additional lead rope 30, using a shackle 35. In embodiments, a plurality of lead ropes 30 may be used, allowing the user to use a plurality of breaching hooks 25. In embodiments, at least two breaching hooks 25 may be used at a time. A user may attach breaching hooks 25 in a “Y” configuration, which may allow for the most advantageous distribution of tension along lead rope 30 and rope 10.

During use, the tension that is exerted on rope 10 and lead rope 30 may exceed the tensile strength of rope 10 or lead rope 30 after a multitude of use. If rope 10 or lead rope 30 has become frayed, cut, or snaps during use, the user may replace that individual rope 10 or a lead rope 30, without replacing the whole breach sling system 5. Replacement rope 10 or replacement lead rope 30 may be attached by a shackle 35.

Although the present invention and its advantages have been described in detail, it should be understood that various changes, substitutions and alterations may be made herein without departing from the spirit and scope of the invention as defined by the appended claims.

What is claimed is:

1. A breach sling system, comprising:
a plurality of ropes, wherein at least two of the ropes are attached to each other, and wherein at least one rope comprises a small loop at one end and a large loop at an opposing end; and
a breaching hook.

2. The breach sling system of claim 1, comprising a lead rope, wherein the lead rope comprises two large loops.

3. The breach sling system of claim 1, wherein one of the ropes are connected to the breaching hook by a shackle and a portion of the plurality of ropes are covered by a sleeve.

4. The breach sling system of claim 6, wherein at least one of the plurality of ropes and the rope each have a large loop and a small loop at opposing ends, and wherein the at least one of the plurality of ropes and the rope connect to each other through the large loop and the small loop.

5. The breach sling system of claim 1, further comprising a deployment bag, wherein the rope and the breaching hook are containable in the deployment bag.

6. The breach sling system of claim 5, wherein the deployment bag comprises an inner compartment, a securing wall, an outer wall, and a plurality of restraint loops.

7. The breach sling system of claim 6, wherein the plurality of restraint loops restrain the rope and the breaching hook within the deployment bag.

8. The breach sling system of claim 10, wherein the deployment bag comprises a rip cord which releases the breaching hook and the rope from the deployment bag.

9. The breach sling system of claim 1, further comprising a carry bag, and a deployment bag, wherein the carry bag comprises a drawstring, which closes the carry bag, concealing the deployment bag within the carry bag.

10. The breach sling system of claim 1, wherein the breaching hook comprises a main member, a gate with a serrated edge, a pointed member, a pocket, and an edge.

11. The breach sling system of claim 1, wherein the breaching hook comprises a vertical member, an upper member, a pointed member, a reinforcement member, and an edge.

12. The breach sling system of claim 1, wherein the breaching hook comprises a wedge member, a breaching member, a vertical member, a cross member, a connection member, a point, and at least one flare.

13. The breach sling system of claim 1, wherein the breaching hook comprises:
a vertical member;
an upper member disposed at an end of the vertical member; and
a pointed member disposed at an end of the upper member, wherein the upper member is disposed between the vertical member and the pointed member.

14. The breach sling system of claim 13, wherein an edge is disposed on the vertical member.

15. The breach sling system of claim 13, wherein the gate comprises a cut-out and a serrated edge.

16. A method for deploying a breach sling system, comprising:
opening a carry bag;
removing a deployment bag from the carry bag;
pulling a rip cord to release a breaching hook and at least one rope;
attaching a lead rope to the at least one rope;
attaching the lead rope to a vehicle;
attaching the breaching hook to a structure; and
driving the vehicle away from the structure.

17. The method of claim 16, wherein the at least one rope is connected to the breaching hook through a shackle.

18. The method of claim 17, wherein the at least one rope and the lead rope are connected through a small loop and a large loop.

19. The method of claim 16, wherein the breaching hook comprises a main member, a gate with a serrated edge, a pointed member, a pocket, and an edge.

20. The method of claim 16, wherein the at least one rope and the breaching hook are restrained within the deployment bag.
